(19) United States
(12) Patent Application Publication
(10) Pub. No.: US 2015/0302322 A1
(43) Pub. Date: Oct. 22, 2015

(54) CLUSTER MEMBERSHIP PLATFORM FOR AIR TRANSPORTATION

(71) Applicant: Profusion Corp., Road Town (VG)

(72) Inventor: Harold Roy Miller, Toronto (CA)

(21) Appl. No.: 14/692,331

(22) Filed: Apr. 21, 2015

Related U.S. Application Data
(60) Provisional application No. 61/982,242, filed on Apr. 21, 2014.

(51) Int. Cl. G06Q 10/02; G06Q 30/06; H04L 29/08

(52) U.S. Cl. CPC G06Q 10/02; H04L 67/10; G06Q 30/0605

(57) ABSTRACT

Methods and systems for air transportation using a cluster membership platform are described herein. A method may include determining a minimum number of passengers for a cluster membership to cover a flight cost. After receiving requests for tickets from two or more passengers, it can be determined that a number of requests is sufficient to provide the two or more passengers with a cluster membership. The two or more passengers may be provided with the cluster membership. Each of the two or more passengers may be provided with the tickets according to the received one or more requests based on a cluster membership policy. The cluster membership policy may include one or more of a ticket price, a membership fee, a flying time cost, and a membership type.

### CROSS-REFERENCE TO RELATED APPLICATION

The present utility patent application is related to and claims the priority benefit under 35 U.S.C. 119(e) of U.S. Provisional Application No. 61/982,242, filed on Apr. 21, 2014, and titled “Cluster Membership Platform for Air Transportation”. The disclosure of this provisional application is incorporated herein by reference for all purposes to the extent that such subject matter is not inconsistent herewith or limiting hereof.

### TECHNICAL FIELD

The present disclosure relates generally to providing air transportation services and, more particularly, to providing air transportation services using a cluster membership platform.

### BACKGROUND

Air transportation systems provide customers with the ability to buy or reserve tickets for specific dates and destinations. However, conventionally, if the travel date is too close, the price of the ticket is considerably higher compared to the price of the same ticket bought in advance. Furthermore, tickets for specific destinations can be completely sold out or the remaining flight times may be inconvenient for the customer. Thus, conventional air transportation systems may not allow the customer to fly to specific destinations on desired dates and at a competitive price. Additionally, because demand can be distributed over a number of different routes, conventional air transportation systems are faced with complex logistics.

Moreover, conventional systems used for various transportation services are based on legacy technologies, require a considerable time to complete analyses, and lack integration with each other. This results in insufficient coherence between the transportation services and other issues that complicate efficient operations of an airline.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for providing air transportation services. Specifically, a method for air transportation using a cluster membership platform includes determining a minimum number of passengers needed for a cluster membership to cover flight costs. After receiving requests for tickets from two or more passengers, it can be determined that a number of requests is sufficient to provide the two or more passengers with a cluster membership. The two or more passengers can be provided with the cluster membership. Each of the two or more passengers can be provided with the tickets according to the received one or more requests based on a cluster membership policy. The cluster membership policy may include one or more of a ticket price, a membership fee, a flying time cost, a membership type, and the like.

According to another approach of the present disclosure, a system for air transportation using a cluster membership platform is provided. The system may include the cluster membership platform operable to determine a minimum number of passengers for a cluster membership to cover flight costs. The cluster membership platform may be operable to receive, from two or more passengers, one or more requests for tickets. Based on the received one or more requests, the cluster membership platform may determine that a number of requests is sufficient to provide the two or more passengers with a cluster membership. Based on the determination, the cluster membership platform may provide the two or more passengers with the cluster membership. Furthermore, the cluster membership platform may provide each of the two or more passengers with the tickets according to the received one or more requests based on a cluster membership policy.

In further example embodiments of the present disclosure, the method operations are stored on a machine-readable medium comprising instructions, which when implemented by one or more processors perform the recited operations. In yet further example embodiments, hardware systems or devices can be adapted to perform the recited operations. Other features, examples, and embodiments are described below.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which a cluster membership platform for air transportation can be implemented.

FIG. 2 is a flow chart illustrating a method for air transportation using a cluster membership platform.

FIG. 3 shows a detailed block diagram of a system for air transportation using a cluster membership platform.

FIG. 4 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure relates to methods and systems for air transportation using a cluster membership platform. A supplier of air transportation services may offer a full range of services to be competitive on the market. The full range of services is important because of integrated functions. The full range of services may include providing customers with the possibility to fly to any destination at any time at costs not substantially greater than costs of a normal first class airline ticket. According to statistical data, there are about 9 million prospective clients in the market for this service. To understand the problem involved, one has to consider that there are about 140,000 city pairs that an airline, such as, for example, United Airlines, may cover by providing a route between these city pairs. Typically, there are as many as 6,000 direct flights between city pairs. Since demand can be distributed over all of the routes, it can become a huge logistical and cost challenge to meet the objective of flying anywhere, any time, and at a price competitive with a first class ticket. Furthermore, flights for numerous clients with same origination and destination cities on a number of different days can be cost prohibitive and result in a financial disaster. The present disclosure describes systems and methods that overcome the issues associated with traditional systems.

More specifically, according to a method of the present disclosure, a minimum number of passengers required to cover a flight cost may be determined. Therefore, the minimum number of passengers may be selected from passengers that requested tickets for the same flight, for example, families or corporate passengers. Upon receiving requests for tickets from the minimum number of passengers, the minimum number of passengers may be provided with a cluster membership. The cluster membership may provide the minimum number of passengers with the right to obtain tickets according to a cluster membership policy. The cluster membership policy may stipulate a specific ticket price for the members of the cluster membership, discounts, specific flying time cost, and other privileges. Several groups of the minimum number of passengers, such as several families or several groups of corporate passengers, may be provided with the cluster membership for the same flight.

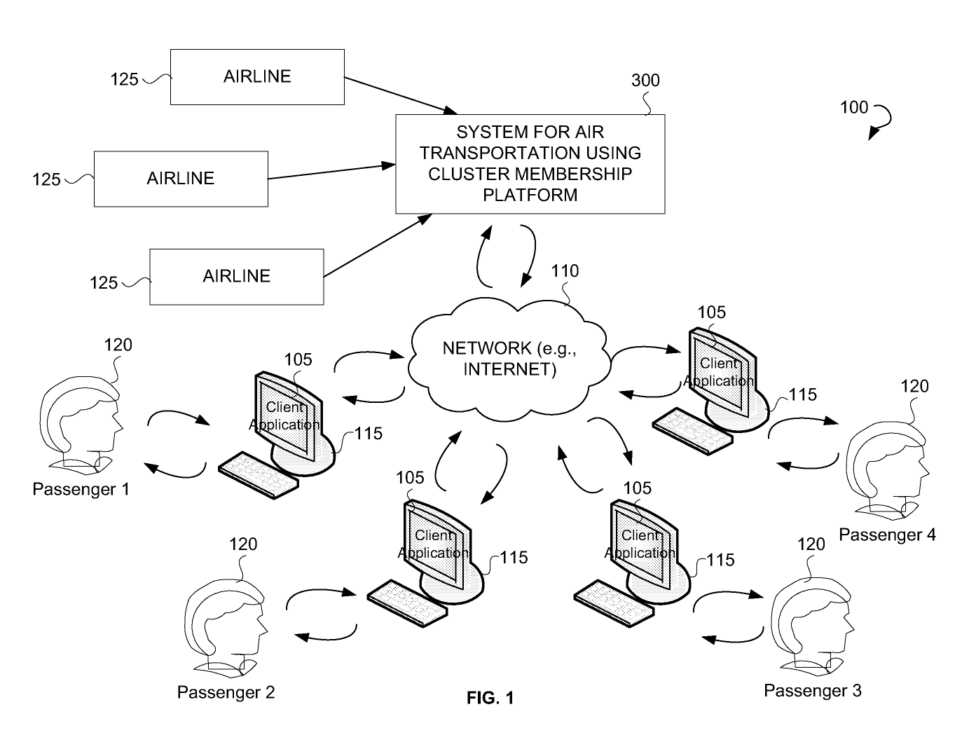

FIG. 1 illustrates an environment 100 within which the systems and methods for air transportation using a cluster membership platform can be implemented. A system 300 for air transportation using a cluster membership platform can be implemented with a server-based distributed application. Thus, the system 300 may include a central component residing on a server (nor shown) and a client application 105 residing on a user device 115 and in communication with the central component via a network 110.

The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, limited duplex paging network, Bluetooth radio, or an IEEE 802.11-based radio frequency network. The network 110 can further include or interface with any one or more of an RS-232 serial connection, an IEEE-1394 (FireWire) connection, a Fiber Channel connection, an infrared port, a Small Computer Systems Interface connection, a Universal Serial Bus connection or other wired or wireless, digital or analog interface or connection, mesh or Digi® networking. The network 110 may include a network of data processing nodes that are interconnected for the purpose of data communication. The network may include a Software-Defined Networking (SDN). The SDN may include one or more of the above network types. Generally, the network 110 may include a number of similar or dissimilar devices connected together by a transport medium enabling communication between the devices by using a predefined protocol. Those skilled in the art will recognize that the present disclosure may be practiced within a variety of network configuration environments and on a variety of computing devices.

The user device 115 may include a personal computer (PC), a laptop, a smartphone, a personal digital device, a tablet computer, and so forth. Passengers 120 can communicate with the system 300 via the client application 105 available through the user device 115. In an example embodiment, the client application 105 includes a website or a software application, such as a mobile application, associated with the system 300.

One or more airlines 125 can access the system 300 and provide air transportation services using the system 300. In particular, one or more airlines 125 can communicate with the system 300 to provide the system 300 with information associated with flights. Information associated with the flights can include a flight schedule, a flight direction, a flight time, a flight cost, ticket availability, and the like.

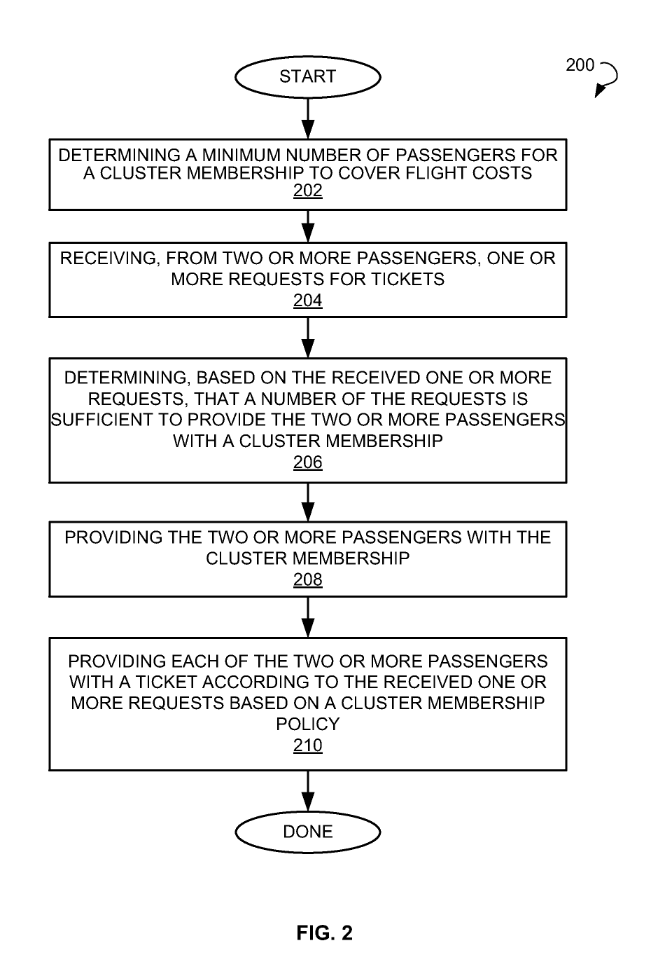

FIG. 2 shows a flow chart illustrating a method 200 for air transportation using a cluster membership platform, according to an example embodiment. In order to make every flight profitable, it is necessary to ensure that there is a minimum number of passengers that pay a specific amount to cover the cost of the flight regardless of an origin and destination. The method 200 may commence with determining, by a cluster membership platform, a minimum number of passengers for a cluster membership to cover a flight cost at operation 202. The minimum number of passengers for the cluster membership represents the minimum number of passengers for which the flight may be profitable. The cost per passenger is the minimum amount to cover the purchase of the flying time. For example, four passengers may constitute the minimum number of passengers.

In an example embodiment, the cluster membership of four passengers is determined as the minimum number of passengers for a cluster membership to cover a flight cost. The cluster membership may reduce the number of potential clients from a pool of 9 million passengers to, e.g., 50,000 clusters of four passengers. However, these four passengers may be able to fly anytime, anywhere and at a specific price.

The method 200 may continue with receiving, from two or more passengers, one or more requests for tickets at operation 204. In an example embodiment, the passengers request tickets on a website or a mobile application associated with the system for air transportation using a user device.

After receiving the one or more requests, the method 200 may further include determining, based on the received one or more requests, that a number of requests is sufficient to provide the two or more passengers with a cluster membership at operation 206. In an example embodiment, the two or more passengers may constitute the minimum number of passengers for the cluster membership. Therefore, determining that the number of requests is sufficient may include determining that the one or more requests are received from the minimum number of passengers. For example, when the number of requests is four, it can be determined that four passengers that requested the tickets may be provided with a cluster membership.

When it is determined that the number of requests is sufficient to provide the two or more passengers with the cluster membership, the two or more passengers may be provided with the cluster membership at operation 208. Finally, each of the two or more passengers may be provided with the ticket according to the received one or more requests at operation 210. The tickets may be provided based on a cluster membership policy. The cluster membership policy may include one or more of the following: a ticket price, a membership fee, a flying time cost, a membership type, and so forth.

Furthermore, according to the cluster membership policy there may be no restrictions on the number of times the passengers who are members of the cluster membership can fly in a year. Therefore, the method 200 may include providing, based on the cluster membership policy, the two or more passengers with a permission to perform an unlimited number of flights per year.

In an example embodiment, a minimum number of flights may be required according to the cluster membership policy. Therefore, the method 200 may include assigning, based on the cluster membership policy, a minimal number of flights per year to be performed by the two or more passengers. Thus, the two or more passengers having the cluster membership can fly every day or once a year, as necessary. In a further example embodiment, the passengers may be charged a membership fee for using the service of the cluster membership platform. Therefore, the economics of providing air transportation according to the described method 200 may be highly consistent with the individual needs.

According to the cluster membership policy, the cost may depend on the flying hours. In an example embodiment, the cost does not depend on a type of membership that is price-based. Thus, in an example embodiment, any four passengers can fly short, medium, or long haul at will. Thus, families or corporate passengers that are members of the cluster membership can get tickets whenever they like.

In an example embodiment, the method 200 may further include receiving a request for tickets on a specific flight from a further passenger. The further passenger may have no cluster membership, but may want to fly with two or more passengers having the cluster membership. The further passenger may be charged a predetermined fee. The predetermined fee may be equal to at least a portion of the membership fee. Upon charging the further passenger, the cluster membership for the specific flight may be provided to the further passenger. Furthermore, the further passenger may be provided with the tickets according to the received request. Therefore, members of the cluster membership can fly in groups including more than the determined minimum number of passengers, e.g., more than four passengers, for half the membership fee for the flight. In this manner, the membership of four passengers can leverage air transportation to greater economic benefit.

In an example embodiment, the method 200 may include determining that a number of the two or more passengers is less than the minimum number of passengers for the cluster membership. In such a case, the two or more passengers may be charged a revised ticket price. The revised ticket price may be an aggregate price for the tickets of the two or more passengers. The revised ticket price may be equal to an aggregate ticket price for the minimum number of passengers. Upon charging, the tickets may be provided to the two or more passengers. For example, on occasion, members of the cluster membership may have to fly with three or fewer passengers. In such a case, the revised ticket price (namely the aggregate price) for three passengers, which are the members of the cluster membership, may be equal to the aggregate ticket price for four tickets (such as for four passengers of the cluster membership). Therefore, the members of the cluster membership may lose money. To encourage the members of the cluster membership to request tickets in the future, the members of the cluster membership may be credited for the overpaid amount of money with free additional tickets on future flights. Alternatively, three passengers, who are members of the cluster membership, may be provided with a credit equal to the price of one extra ticket overpaid by three passengers when they bought three tickets at the price of four tickets.

Additionally, individual members can piggyback on any planned flights for the cost approximately equal to a first class ticket cost. In this manner, individual members can be signed on as well. For example, four members of the cluster membership can piggyback as well for, e.g., a half of the ticket price. A number of individual options can be provided to the members of the cluster membership as membership grows and the network of flights grows.

Travelers who are not members of the cluster membership can be added as a club membership arrangement to piggyback on existing schedules. The non-cluster membership members may be allowed to piggyback on existing schedules, for example, at a First Class Commercial ticket price.

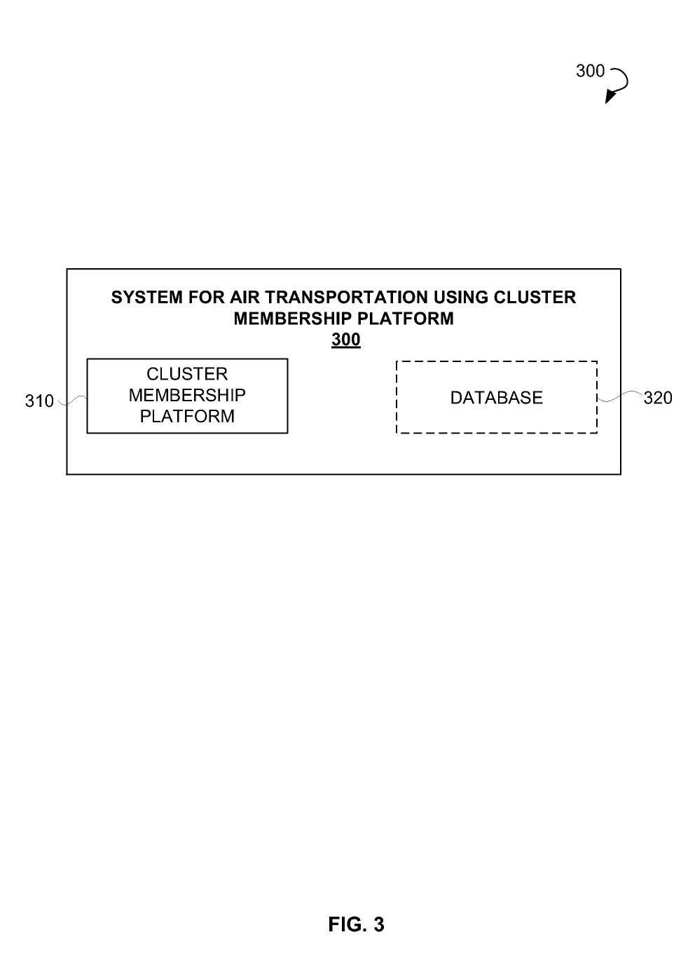

FIG. 3 is a detailed block diagram of a system 300 for air transportation using cluster membership platform, according to an example embodiment. The system 300 may include a cluster membership platform 310. The cluster membership platform 310 may be operable to determine a minimum number of passengers for a cluster membership to cover a flight cost. Furthermore, the cluster membership platform 310 may be operable to receive, from two or more passengers, one or more requests for a ticket. Upon receiving the requests, the cluster membership platform 310 may determine, based on the received one or more requests, that a number of requests is sufficient to provide the two or more passengers with a cluster membership. Furthermore, the cluster membership platform 310 may be operable to provide the two or more passengers with the cluster membership. The cluster membership platform 310 may be further operable to provide each of the two or more passengers with the ticket according to the received one or more requests. The tickets may be provided based on a cluster membership policy. The cluster membership policy may include one or more of a ticket price, a membership fee, a flying time cost, a membership type, and so forth.

The system 300 can further optionally include a database 320. The database 320 may be configured to store data associated with the cluster membership platform, such as member identification data, data provided by one or more airlines, data associated with the cluster membership policy, and so forth.

Providing air transportation using the system 300 of the present disclosure can be profitable from the first day of using the system 300 and on every flight. The potential passengers can request tickets without restrictions associated with time or destination. The passengers do not have to be coerced into large expenditures. The passengers can join the cluster membership and fly as often as they need: once a year as a family trip, or once a week as a business trip. As the number of members grows, the cost of tickets can come down.

### Example of Membership Volume Estimation

According to statistical data, it can be expected for family trips that there may be a substantial number of flights a year. It can be assumed that there may be about 5,000 flights a year. There may be about 40 million business travelers a year in the United States. These travelers can take 5.5 trips each. It can be assumed that about 1% of flights involve at least four persons. This means that there are about 2,000,000 trips of four persons a year. It can be assumed that 5% of the flights consisting of four persons can use the system 300 of the present disclosure as members of the cluster membership. These members of the cluster membership may make 100,000 trips a year. This may equate to about 400,000 memberships by way of volume.

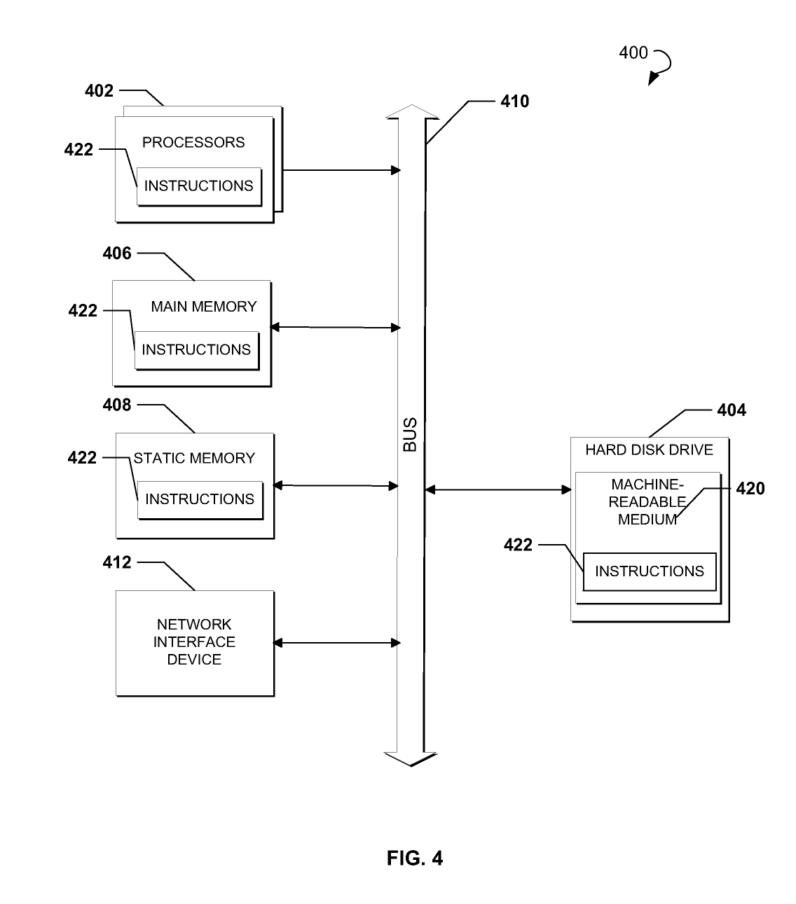

FIG. 4 shows a diagrammatic representation of a computing device for a machine in the exemplary electronic form of a computer system 400, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a server, a PC, a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 400 includes a processor or multiple processors 402, a hard disk drive 404, a main memory 406, and a static memory 408, which communicate with each other via a bus 410. The computer system 400 may also include a network interface device 412. The hard disk drive 404 may include a machine-readable medium 420, which stores one or more sets of instructions 422 embodying or utilized by any one or more of the methodologies or functions described herein. The instructions 422 can also reside, completely or at least partially, within the main memory 406 and/or within the processors 402 during execution thereof by the computer system 400. The main memory 406 and the processors 402 also constitute machine-readable media.

While the machine-readable medium 420 is shown in an exemplary embodiment to be a single medium, the term “machine-readable medium” can be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “machine-readable medium” shall accordingly be taken to include, but not be limited to, solid-state memories, optical and magnetic media. Such media can also include, without limitation, hard disks, floppy disks, NAND or NOR flash memory, digital video disks, random access memory, read-only memory, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, Python, JavaScript, Go, or other compilers, assemblers, interpreters or other computer languages or platforms.

Thus, a system for air transportation using a cluster membership platform and a method for air transportation using the cluster membership platform have been described herein. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A method for air transportation using a cluster membership platform, the method comprising:
determining a minimum number of passengers for a cluster membership to cover a flight cost;
receiving, from two or more passengers, one or more requests for tickets;
determining, based on the one or more requests, that a number of the requests is sufficient to provide the two or more passengers with the cluster membership;
providing the two or more passengers with the cluster membership; and
providing each of the two or more passengers with the tickets according to the one or more requests based on a cluster membership policy.

2. The method of claim 1, wherein the cluster membership policy includes one or more of the following: a ticket price, a membership fee, a flying time cost, and a membership type.

3. The method of claim 1, wherein the determining that the number of requests is sufficient includes determining that the one or more requests are received from the minimum number of passengers.

4. The method of claim 1, wherein the receiving of the one or more requests includes receiving the one or more requests using one or more of a website associated with the cluster membership platform and a mobile application associated with the cluster membership platform.

5. The method of claim 1, further comprising charging the two or more passengers a membership fee.

6. The method of claim 5, further comprising:
receiving, from a further passenger, a request for tickets on a specific flight;
providing the further passenger with the cluster membership for the specific flight;
charging the further passenger a predetermined fee, the predetermined fee being equal to at least a portion of the membership fee; and
providing the further passengers with the tickets according to the request.

7. The method of claim 1, further comprising providing, based on the cluster membership policy, the two or more passengers with a permission to perform an unlimited number of flights per year.

8. The method of claim 1, further comprising assigning, based on the cluster membership policy, a minimal number of flights per year to be performed by the two or more passengers.

9. The method of claim 1, wherein the two or more passengers constitute the minimum number of passengers for the cluster membership.

10. A system for air transportation using a cluster membership platform, the system comprising:
a cluster membership platform operable to:
determine a minimum number of passengers for a cluster membership to cover a flight cost;
receive, from two or more passengers, one or more requests for tickets;
determine, based on the one or more requests, that a number of requests is sufficient to provide the two or more passengers with the cluster membership;
provide the two or more passengers with the cluster membership; and
provide each of the two or more passengers with the tickets according to the one or more requests based on a cluster membership policy.

11. The system of claim 10, wherein the cluster membership policy includes one or more of the following: a ticket price, a membership fee, a flying time cost, and a membership type.

12. The system of claim 10, wherein the cluster membership platform determines that the number of requests is sufficient based on determining that the one or more requests are received from the minimum number of passengers.

13. The system of claim 10, wherein the one or more requests are received using one or more of a website associated with the cluster membership platform and a mobile application associated with the cluster membership platform.

14. The system of claim 10, wherein the cluster membership platform is further operable to charge the two or more passengers a membership fee.

15. The system of claim 14, wherein the cluster membership platform is further operable to:
receive, from a further passenger, a request for tickets on a specific flight;
provide the further passenger with the cluster membership for the specific flight;
charge the further passenger a predetermined fee, the predetermined fee being equal to at least a portion of the membership fee; and
provide the further passengers with the tickets according to the request.

16. The system of claim 10, wherein the cluster membership platform is further operable to provide, based on the cluster membership policy, the two or more passengers with a permission to perform an unlimited number of flights per year.

17. The system of claim 10, wherein the cluster membership platform is further operable to assign, based on the cluster membership policy, a minimal number of flights per year to be performed by the two or more passengers.

18. The system of claim 10, wherein the two or more passengers constitute the minimum number of passengers for the cluster membership.

19. The system of claim 10, wherein the cluster membership platform is further operable to:
determine that a number of the two or more passengers is less than the minimum number of passengers for the cluster membership; and
charging the two or more passengers a revised ticket price, the revised ticket price being an aggregate price for the tickets of the two or more passengers, the revised ticket price being equal to an aggregate ticket price for the minimum number of passengers.

20. A non-transitory processor-readable medium having embodied thereon a program being executable by at least one processor to perform a method for air transportation using a cluster membership platform, the method comprising:
determining a minimum number of passengers for a cluster membership to cover a flight cost;
receiving, from two or more passengers, one or more requests for tickets;
determining, based on the one or more requests, that a number of requests is sufficient to provide the two or more passengers with the cluster membership;
providing the two or more passengers with the cluster membership; and
providing each of the two or more passengers with the tickets according to the one or more requests based on a cluster membership policy.
